(19) United States
(12) Patent Application Publication
(10) Pub. No.: US 2007/0125118 A1
(43) Pub. Date: Jun. 7, 2007

(54) Ice chest

(76) Inventor: Frederick Arnold Hooper, Devonport (AU)

Correspondence Address: STIENNON & STIENNON, 612 W. MAIN ST., SUITE 201, P.O. BOX 1667, MADISON, WI, 53701-1667, US

(21) Appl. No.: 11/295,158

(22) Filed: Dec. 6, 2005

(51) Int. Cl. B67D 5/62; F25D 3/08; F25D 3/02

(52) U.S. Cl. 62/389; 62/457.7; 62/462

(57) ABSTRACT

An ice chest (1) has a dividing wall (11), preferably formed from an end wall of a container (10) sized to fit within the ice chest (1). The space between the interior of the ice chest and the dividing wall constitutes an ice receiving cavity which, when filled with ice, can function as an ice bucket to provide extra cooling to one bottle (30) in contact with the ice, whilst remaining bottles (31) are maintained cool, but at a higher temperature, and dry within the container (10). Melt water from the ice is separated by the container (10) from the general contents of the ice chest and thus is not contaminated by bacteria and may be drunk following dispensing via a drain cock (8). A method of cooling is also disclosed.

### BACKGROUND OF THE INVENTION

The present invention relates to cooling devices, and, in particular, to a portable ice chest of the type used by campers, picnickers, and the like.

Traditionally such ice chests have been sold under the trade name ESKY or ESKIE in Australia (or CHILLIE BIN in New Zealand) and consist of an insulated body with a removable lid. Typically the body is formed from inner and outer walls which are insulated by polystyrene foam, or similar insulation material.

Generally, in order to keep the contents of the ice chest cold, a block of ice, crushed ice, or a cooler brick (i.e. a body of water encapsulated in a container and which is able to be frozen) is used to chill the contents of the ice chest. Each of these stratagems suffers from various drawbacks. The block of ice and crushed ice if allowed to come into contact with food, generally spoil food by either freezing part of it, or wetting the entirety of the food. A cooler brick suffers from the disadvantage, particularly when camping, that once at ambient temperature, the brick is too valuable to discard and therefore takes up valuable space and weight, particularly on the home trip.

### SUMMARY OF THE INVENTION

The object of the present invention is to go some way towards overcoming, or at least ameliorating, some of the abovementioned disadvantages.

In accordance with a first aspect of the present invention there is disclosed an ice chest having a thermally insulated body and lid, at least one dividing wall located interior of said chest and in liquid communication with an occludeable drain leading through said insulated body adjacent the base of said body and to the exterior of said chest, said dividing wall defining an ice receiving cavity adapted to receive crushed ice and function as an ice bucket located interior of said ice chest.

In accordance with a second aspect of the present invention there is disclosed a method of sequentially providing extra cooling to a plurality of drinkable liquid containers, said method comprising the steps of:

(i) forming an ice receiving cavity within an ice chest by providing at least one dividing wall with the ice chest interior,

(ii) placing ice in said ice receiving cavity to thereby form an ice bucket,

(iii) placing one of said drinkable liquid containers in said ice bucket in contact with said ice,

(iv) placing the remainder of said drinkable liquid containers in said ice chest but not in said ice receiving cavity and not in contact with said ice,

(v) closing the lid of said ice chest,

(vi) from time to time opening the lid of said ice chest, removing said one drinkable liquid container from said ice bucket and ice chest, replacing same with one of said drinkable liquid containers from said remainder, and closing the lid of said ice chest, and

(vii) if necessary, repeating step (vi) until all said drinkable liquid containers are removed from said ice chest.

A preferred embodiment of the present invention will now be described with reference to the drawings.

### BRIEF DESCRIPTION OF THE DRAWINGS

FIG. 1 is a longitudinal cross-sectional view taken through the ice chest of the preferred embodiment.

FIG. 2 is a view similar to FIG. 1 and showing the ice chest in use.

### DESCRIPTION OF THE PREFERRED EMBODIMENTS

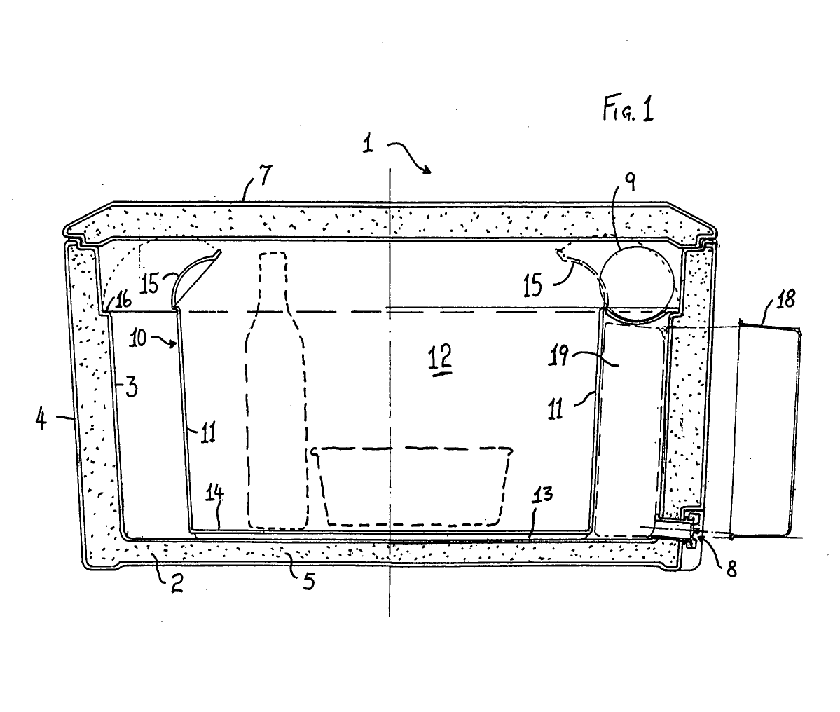

As seen in FIG. 1 the ice chest 1 takes the form of an insulated body 2 having an inner wall 3 and an outer wall 4 separated by insulation 5. A lid 7 closes the body 2 and is similarly insulated. A drain cock 8 passes between the inner and outer walls 3, 4 at the base of the body 2. The above construction is thus far substantially conventional.

In addition, a removable inner container 10 is provided which is preferably molded from plastics material to have thin walls which are thus moderate conductors of heat rather than being either insulators or good conductors of heat. As seen in FIG. 1 the removable rectangular container has a pair of end walls 11, two side walls 12 (only one of which is illustrated) and a number of longitudinally extending ribs 13 (only one of which is illustrated) located under the base 14 of the container 10. At the upper edge of each of the end walls 11 is pivoted a corresponding one of two curved covers 15.

The container 1 is dimensioned so that there is a space between each end wall 11 and the inner wall 3 of the body 2 and this space is able to be closed by the corresponding cover 15 which rests on a lip 16 formed in the inner wall 3. As indicated in FIG. 1 the cover 15 is able to support a cylindrical object such as a bottle or can 9.

Also illustrated in FIG. 1 is a plastic open topped receptacle 18 which is dimensioned to just fit within the space between the inner wall 3 and the adjacent end wall 11. The receptacle 18 is a convenient mold from which an ice block 19 can be formed by freezing liquid in a conventional refrigerator/freezer.

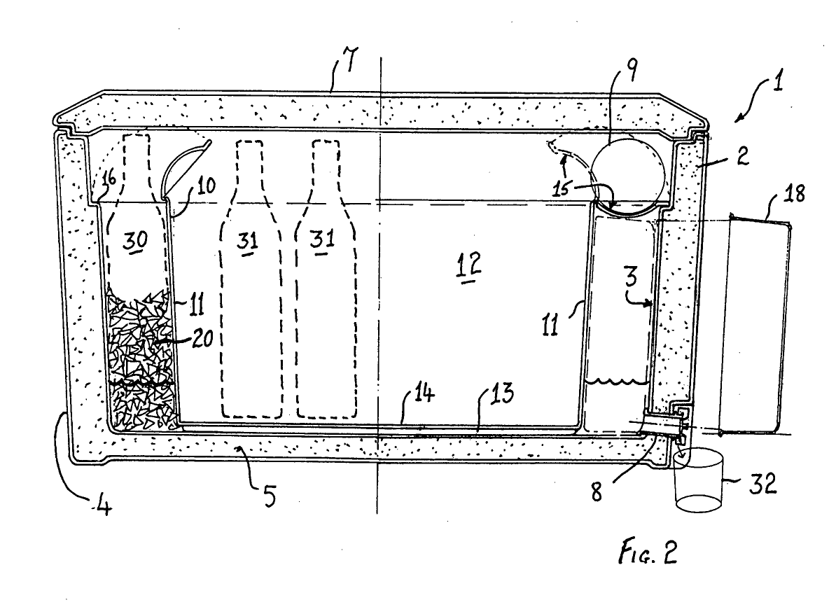

Turning now to FIG. 2 the ice chest 1 in use is illustrated showing crushed ice 20 located between the inner wall 3 and one of the end walls 11. Locating the crushed ice 20 in the space defined between the body 2 and the container 10 has a number of substantial advantages. Firstly, the crushed ice is contained within a defined volume and can therefore be used as an ice bucket to specifically chill an individual bottle 30 immediately prior to its being consumed, as opposed to a number of further bottles 31 which can be maintained at a low temperature within the container 10, but not as cold as the bottle 30 in contact with the crushed ice.

Secondly, the contents of the container 10 are entirely dry. Thus the container 10 can be used to store food items without such food items being either wetted or frozen as a result of coming into contact with ice.

Thirdly, the melt water produced by the crushed ice 20 is able to be drained from the ice chest 1 via the cock 8 into a drinking glass 32 or similar vessel. That is, the ice chest 1 is able to function as a cool drink dispenser. This function is able to be enhanced if the frozen ice block 19, or crushed ice 20 is created by freezing a prepared drink such as children's cordial. In particular, this stratagem ensures that the weight and volume which would otherwise be occupied by the cooler brick on the return trip is avoided since the corresponding ice block 19 or crushed ice 20 has been both melted and consumed.

Many connoisseurs of champagne and other wines appreciate being able to consume the wine at a temperature very close to the freezing point of water (zero degrees C.). The above described arrangement enables a plurality of champagne bottles to be taken on a camping trip and maintained at a cool temperature (say 5 degrees C.) but above freezing for some time, and each bottle in turn is able to be placed in the ice bucket immediately prior to consumption for final chilling to the desired consumption temperature. This procedure is not available with conventional style chests.

The foregoing describes only one embodiment of the present invention and modifications, obvious to those skilled in the art, can be made thereto without departing from the scope of the present invention.

The term “comprising” (and its grammatical variations) as used herein is used in the inclusive sense of “having” or “including” and not in the exclusive sense of “consisting only of”.

I claim:

1. An ice chest having a thermally insulated body and lid, at least one dividing wall located interior of said chest and in liquid communication with an occludeable drain leading through said insulated body adjacent the base of said body and to the exterior of said chest, said dividing wall defining an ice receiving cavity adapted to receive crushed ice and function as an ice bucket located interior of said ice chest.

2. The ice chest as claimed in claim 1 wherein said dividing wall comprises a wall of an interior container dimensioned to be received within said body.

3. The ice chest as claimed in claim 2 wherein said ice receiving cavity is formed between the interior of said body and the exterior of said container.

4. The ice chest as claimed in claim 3 wherein said ice receiving cavity is provided with a pivotable lid.

5. The ice chest as claimed in claim 4 wherein said pivotable lid is curved to support a bottle or can.

6. The ice chest as claimed in claim 2 wherein said interior container has a plurality of external ribs formed in the base thereof.

7. A method of sequentially providing extra cooling to a plurality of drinkable liquid containers, said method comprising the steps of:
(i) forming an ice receiving cavity within an ice chest by providing at least one dividing wall with the ice chest interior;
(ii) placing ice in said ice receiving cavity to thereby form an ice bucket;
(iii) placing one of said drinkable liquid containers in said ice bucket in contact with said ice;
(iv) placing the remainder of said drinkable liquid containers in said ice chest but not in said ice receiving cavity and not in contact with said ice;
(v) closing the lid of said ice chest;
(vi) from time to time opening the lid of said ice chest, removing said one drinkable liquid container from said ice bucket and ice chest, replacing same with one of said drinkable liquid containers from said remainder, and closing the lid of said ice chest; and
(vii) if necessary, repeating step (vi) until all said drinkable liquid containers are removed from said ice chest.

8. The method as claimed in claim 7 including the step of forming said dividing wall from the wall of an interior container dimensioned to be received within said ice chest, whereby said ice receiving cavity is defined by a space between the interior of said ice chest and the exterior of said interior container.
